(19) United States
(12) Patent Application Publication
(10) Pub. No.: US 2025/0388180 A1
(43) Pub. Date: Dec. 25, 2025

(54) VEHICLE EXTERIOR COMPONENT

(71) Applicant: TOYODA GOSEI CO., LTD., Kiyosu-shi (JP)

(72) Inventors: Masahiko NAKAISHI, Kiyosu-shi (JP); Akihiro HIROSE, Kiyosu-shi (JP); Yasuhiro HADA, Kiyosu-shi (JP); Atsushi KUMO, Kiyosu-shi (JP); Riku OKAMURA, Kiyosu-shi (JP)

(21) Appl. No.: 19/219,538

(22) Filed: May 27, 2025

(30) Foreign Application Priority Data
Jun. 21, 2024 (JP) 2024-100452

(51) Int. Cl. B60R 13/00

(52) U.S. Cl. CPC B60R 13/005

(57) ABSTRACT

A vehicle exterior component includes a base layer formed from a resin material having visible light transmittance and a decorative layer laminated onto the base layer. The decorative layer includes first and second layers formed from a resin material having a coefficient of linear expansion differing from that of the first layer. The first layer includes a first base portion laminated onto the base layer and a peripheral portion projecting from an edge of the first base portion. The second layer includes a second base portion laminated onto the first base portion and a projecting portion extending through the first base portion. The peripheral portion faces the second base portion in a radial direction with a gap in between.

### CROSS-REFERENCE TO RELATED APPLICATIONS

This application is based upon and claims the benefit of priority from Japanese Patent Application No. 2024-100452, filed on Jun. 21, 2024, the entire contents of which are incorporated herein by reference.

### BACKGROUND

### 1. Field

The following description relates to a vehicle exterior component.

### 2. Description of Related Art

Japanese Laid-Open Patent Publication No. 2022-151599 discloses a vehicle exterior component. The vehicle exterior component includes an ornamental body and a light diffusion reflector arranged at the rear of the ornamental body. The ornamental body includes a rear base, a light shield, a front base, and a decorative layer.

The rear base is a member forming the rear half of the ornamental body. The rear base includes a general portion and a ridge-like projection portion projecting frontward of the general portion. The projection portion corresponds to a pattern region of the vehicle exterior component. The general portion corresponds to a background region of the vehicle exterior component.

The light shield blocks the transmission of light by absorbing light. The light shield includes a peripheral light shield portion and an intermediate light shield portion. The peripheral light shield portion is arranged along an edge portion of the rear base and closely contacts the edge portion. The rear end surface of the peripheral light shield portion is bonded to the edge portion of the light diffusion reflector. The intermediate light shield portion is arranged frontward of the general portion of the rear base.

The front base is a transparent member that forms the front half of the ornamental body. The front base is located frontward of the rear base and the light shield. The edge portion of the front base closely contacts the peripheral light shield from the front. A portion of the front base located in front of the intermediate light shield contacts the intermediate light shield portion closely from the front.

The decorative layer is formed on the rear base and between the light shield and the front base.

Further, in the vehicle exterior component of the above publication, the rear base is formed from a resin material that differs from that of the light shield and the front base.

After the vehicle exterior component is attached to the vehicle, changes in the ambient temperature cause the ornamental body to repeat thermal expansion and thermal contraction in the radial direction of the ornamental body. Thus, the difference in coefficient of linear expansion causes displacement of the light shield and the front base relative to the rear base. This results in the concentration of stress at the interface between the edge portion of the rear base and the peripheral shield portion. As a result, the edge portion may become separated from the peripheral shield portion. Therefore, in the ornamental body, for example, a projection and a recess that are engaged with each other may be arranged on the edge portion of the rear base and the peripheral shield portion to produce an anchoring effect that firmly bonds the edge portion and the peripheral shield portion together. This, however, causes the structure of the rear base and the light shield to be complicated.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a vehicle exterior component includes a base layer forming from a resin material having visible light transmittance. A decorative layer is laminated onto an inner surface of the base layer. The decorative layer includes a first layer and a second layer that are formed from a resin material having a coefficient of linear expansion differing from that of the resin material of the first layer. The first layer includes a first base portion laminated onto and bonded with an inner surface of the base layer and a peripheral portion projecting from an edge of the first base portion toward an inner side of a vehicle. The second layer includes a second base portion laminated onto an inner surface of the first base portion and a projecting portion projecting from the second base portion and extending through the first base portion. A direction radially extending from a center of the decorative layer is defined as a radial direction. The peripheral portion faces a peripheral surface of the second base portion in the radial direction with a gap in between.

Other features and aspects will be apparent from the following detailed description, the drawings, and the claims.

### BRIEF DESCRIPTION OF THE DRAWINGS

FIG. 1 is a front view of a luminous emblem that includes a cover of the first embodiment.

FIG. 2 is a cross-sectional view taken along line 2-2 in FIG. 1.

FIG. 3 is a rear view of the cover shown in FIG. 1.

FIG. 4 is a cross-sectional view taken along line 4-4 in FIG. 3.

FIG. 5 is a rear view corresponding to FIG. 3 and showing a cover of the second embodiment.

FIG. 6 is a cross-sectional view taken along line 6-6 in FIG. 5.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

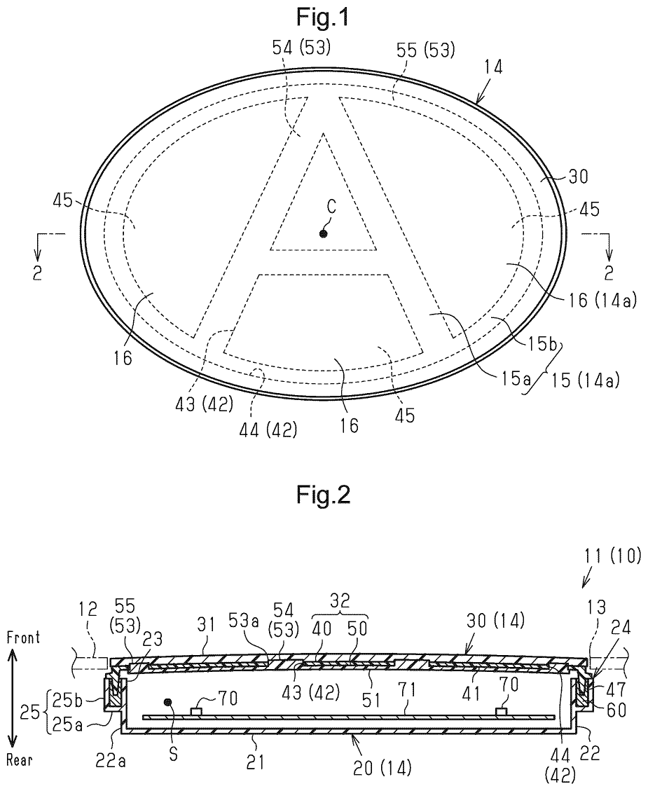

Each embodiment of a vehicle exterior component will now be described with reference to FIGS. 1 to 6.

### First Embodiment

A vehicle exterior component according to a first embodiment will now be described with reference to FIGS. 1 to 4. In the first embodiment, a cover 30 of a luminous emblem 14 is attached to a vehicle 10.

In the description hereafter, the front-rear direction of the vehicle 10 is referred to as the front-rear direction. The front and rear in the front-rear direction will simply be referred to as the front and rear. Further, in the present embodiment, the outward and inward directions with respect to the vehicle 10 respectively corresponds to front and rear direction. Therefore, “out” and “outward” will be referred to as “front” and “frontward”, and “in” or “inward” will be referred to as “rear” and “rearward”.

### Luminous Emblem

As shown in FIGS. 1 and 2, a front portion 11 of the vehicle 10 includes a front panel 12 that forms part of an exterior body of the front portion 11. The front panel 12 includes a window 13 that opens toward the front of the vehicle 10. The luminous emblem 14 is fitted into the window 13. In the present embodiment, the luminous emblem 14 is arranged in a direction orthogonal to the front-rear direction (refer to FIG. 2).

As shown in FIG. 1, the luminous emblem 14 is circular in a front view. Therefore, the direction that extends radially from the center C of the luminous emblem 14 will be referred to as the radial direction in the description hereafter. Furthermore, the side that is closer to the center C will be referred to as inner side and the side that is farther from the center C will be referred to as the outer side.

The luminous emblem 14 has an ornamental surface 14a including a display region 15 and a background region 16. The display region 15 displays a mark facing the front. The background region 16 is the portion that is not the display region 15. Here, “mark” may be stylized text (logotype) indicating the manufacturer, model, grade, or the like of the vehicle 10; a shape (symbol mark) representing the manufacturer of the vehicle 10, or a logo combining characters and shapes. In the present embodiment, the display region 15 includes a character portion 15a that shows the Latin character “A” and an annular portion 15b that extends along the edge of the luminous emblem 14 and surrounds the character portion 15a.

The luminous emblem 14 includes a housing 20, a cover 30, and light sources 70. Each component will now be described.

### Housing 20

As shown in FIG. 2, a housing 20 accommodates the light sources 70. The housing 20 includes a bottom wall 21, a peripheral wall 22, and a groove 24. The peripheral wall 22 rises frontward of the edge of the bottom wall 21. An opening 23 is formed in the front end of the peripheral wall 22. A groove formation portion 25 is formed on the outer side of the peripheral wall 22. The groove formation portion 25 includes a first part 25a and a second part 25b. The first part 25a projects from an outer surface 22a of the peripheral wall 22. The second part 25b bends at the distal end of the first part 25a and then extends toward the front. The groove formation portion 25 and a part of the peripheral wall 22 form the groove 24 that extends in an annular manner.

The housing 20 is molded integrally from a resin material in which particles of white light diffusing material are dispersed. The resin material may be, for example, acrylonitrile-butadiene-styrene copolymer (ABS) resin or the like. The light diffusing material may be, for example, a metal oxide such as titanium oxide or as zinc oxide.

### Cover 30

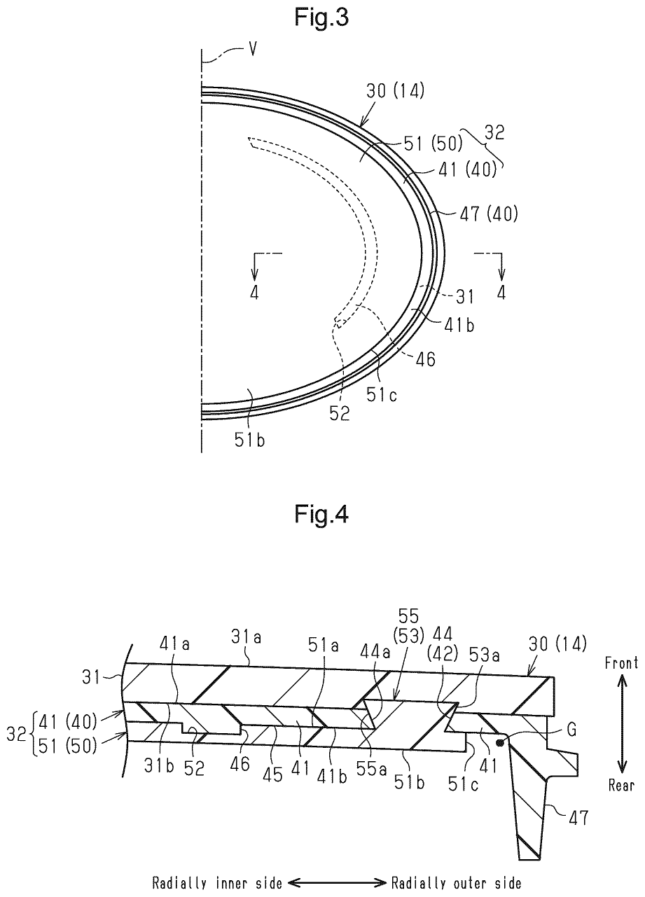

As shown in FIGS. 2 to 4, the cover 30 covers the opening 23 of the housing 20 from the front. The cover 30 has a symmetrical shape with respect to a virtual plane V that extends in both the front-rear direction and the vertical direction of the vehicle 10. Therefore, FIG. 3 shows only the right portion of the cover 30 with respect to the vehicle lateral portion as viewed from the rear of the vehicle 10. FIG. 3 does not show the left portion of the cover 30.

As shown in FIGS. 2 and 4, the cover 30 is formed by a plate having a substantially constant thickness. The cover 30 is bulged toward the front and curved gradually. The cover 30 includes a base layer 31 and a decorative layer 32.

The base layer 31 forms the front half of the cover 30. The base layer 31 includes a front surface 31a that defines the front surface of the cover 30 (refer to FIG. 4). The base layer 31 is plate-shaped and formed from a resin material having visible light transmittance. The resin material may be, for example, an acrylic resin such as polymethyl methacrylate (PMMA) or a transparent resin such as polycarbonate (PC). In the present embodiment, the base layer 31 is formed from PC. In the present embodiment, transparency includes colorless transparency and colored transparency.

The decorative layer 32 includes a first layer 40 and a second layer 50.

The first layer 40 includes a first base portion 41 and a peripheral portion 47. A front surface 41a of the first base portion 41 is laminated onto and bonded with a rear surface 31b of the base layer 31 (refer to FIG. 4). The first base portion 41 includes through holes 42 that extend through the first base portion 41 in the front-rear direction.

As shown in FIG. 1, the through holes 42 correspond to the display region 15. More specifically, the through holes 42 include an inner through hole 43 that corresponds to character portion 15a and an outer through hole 44 that corresponds to the annular portion 15b. The portion of the first base portion 41 excluding the through holes 42 that is hereafter referred to as the general portion 45 corresponds to the background region 16.

As shown in FIGS. 3 and 4 the rear surface 41b of the first base portion 41 includes a protrusion 46 that projects toward the rear. In the present embodiment, the protrusion 46 projects from the general portion 45 and extends along the edge of the first base portion 41 (refer to FIG. 3).

As shown in FIG. 2, the peripheral portion 47 projects from the edge of the first base portion 41 toward the rear. A rear end portion of the peripheral portion 47 is embedded in an adhesive layer 60 with which the groove 24 is filled. This bonds the cover 30 to the housing 20 and defines an accommodating space S that is sealed from the outside between the cover 30 and the housing 20.

In the present embodiment, the first layer 40 is formed from a material that blocks visible light. The first layer 40 is colored black and absorbs visible light to block visible light transmission. The first layer 40 is formed from, for example, a mixture of a transparent resin, such as PC, and a black pigment, such as carbon black. In the present embodiment, the first layer 40 is formed from PC.

As shown in FIGS. 2 to 4, the second layer 50 includes a second base portion 51 and a projecting portion 53.

As shown in FIG. 4, a front surface 51a of the second base portion 51 is laminated onto the rear surface 41b of the first base portion 41. A rear surface 51b of the second base portion 51 defines the rear surface of the cover 30. The second base portion 51 includes a peripheral surface 51c facing the peripheral portion 47 in the radial direction with a gap G in between. In the present embodiment, the gap G extends between the entire peripheral surface 51c and the peripheral portion 47.

As shown in FIGS. 3 and 4, the front surface 51a of the second base portion 51 includes a recess 52 into which the protrusion 46 is tightly fitted. The protrusion 46 and the recess 52 are shaped to engage with each other.

As shown in FIGS. 2 and 4, the projecting portion 53 projects from the front surface 51a of the second base portion 51 toward the front and extends through the first base portion 41. The projecting portion 53 includes a distal end 53a embedded in the rear surface 31b of the base layer 31. In the present embodiment, the front-rear direction corresponds to the projecting direction of the projecting portion 53. The through hole 42 allows the projecting portion 53 to be visible from the front through the base layer 31.

As shown in FIG. 1, the projecting portion 53 forms the display region 15. The projecting portion 53 includes an inner projecting portion 54 that corresponds to the character portion 15a and an outer projecting portion 55 that corresponds to the annular portion 15b.

As shown in FIGS. 2 and 4, the inner projecting portion 54 is fitted tightly into the inner through hole 43. The outer projecting portion 55 is fitted tightly into the outer through hole 44. The outer projection portion 55 and the outer through hole 44 each have a dimension measured in the radial direction that decreases in the front-rear direction toward a basal end of the outer projecting portion 55 (refer to FIG. 4). In other words, a surface 55a of the outer projecting portion 55 and an inner surface 44a of the outer through hole 44, which engage with each other, are inclined to become closer to the center of the outer projecting portion 55 in the radial direction as the basal end of the outer projecting portion becomes closer in the front-rear direction.

The second layer 50 is formed from a resin material that has a different coefficient of linear expansion from that of the first layer 40. In order to uniformly illuminate the mark, the second layer 50 is preferably formed from a resin material in which particles of white light diffusing material are dispersed. The resin material may be, for example, a visible light transmissive material, such as styrene-acrylonitrile resin (AS), poly (methyl methacrylate), PMMA, or the like. In the present embodiment, the second layer 50 is formed from AS. The light diffusing material may be for example, barium sulfate.

A metal film (not shown) having an island structure is arranged between the base layer 31 and the projecting portion 53, and between the first base portion 41 and the second base portion 51. The metal film is formed, for example, by performing sputtering or vacuum deposition on a metal material such as indium (In). When the light sources 70 are not generating light, the metal film provides a metallic luster to the mark displayed in the display region 15.

### Light Sources 70

As shown in FIG. 2, the light sources 70 emit visible light toward the front and may be a light-emitting element such as a light-emitting diode (LED) or the like. In a state disposed on a substrate 71, the light sources 70 are accommodated in the housing 20; more specifically, in the accommodating space S.

In the luminous emblem 14, the light emitted from the light sources 70 is blocked by the first base portion 41 and the peripheral portion 47 of the first layer 40. Part of the light is transmitted through the projecting portion 53 of the second layer 50 and emitted toward the front of the vehicle 10. This illuminates and displays the mark toward the front of the vehicle 10.

### Operation of First Embodiment

When the cover 30 thermally expands or thermally contracts due to the changes in the ambient temperature, the gap G absorbs relative displacement between the first layer 40 and the second layer 50 caused by the difference in the coefficient of linear expansion between the first layer 40 and the second layer 50. This restricts contact between the peripheral surface 51c of the second base portion 51 and the peripheral portion 47 of the first layer 40 in the radial direction. Thus, separation of the second layer 50 is obviated that would be caused by the concentration of stress at the interface between the peripheral surface 51c and the peripheral portion 47.

In the cover 30 of the present embodiment, when compared to the conventional cover of the luminous emblem where the second base portion 51 and the peripheral portion 47 of the first layer 40 are in close contact, the second base portion 51 and the peripheral portion 47 do not need to be engaged with each other to restrict separation of the second layer 50.

### Advantages of First Embodiment

(1-1) The cover 30 includes the base layer 31, which is formed from a resin material that has visible light transmittance, and the decorative layer 32, which is laminated onto the rear surface 31b of the base layer 31. The decorative layer 32 includes the first layer 40 and the second layer 50 that is formed from a resin material that has a coefficient of linear expansion that is different from that of the first layer 40. The first layer 40 includes the first base portion 41, which is laminated onto and bonded with the rear surface 31b of the base layer 31, and the peripheral portion 47 projecting rearward of the edge of the first base portion 41. The second layer 50 includes the second base portion 51, which is laminated onto the rear surface 41b of the first base portion 41, and the projecting portion 53, which projects from the second base portion 51 and extends through the first base portion 41. The peripheral portion 47 faces the peripheral surface 51c of the second base portion 51 in the radial direction with the gap G in between.

This structure results in the effects described above. Thus, separation of the second layer 50 can be avoided with a simple structure.

(1-2) The projecting portion 53 includes the outer projecting portion 55, which projects from the edge of the second base portion 51. The first base portion 41 includes the outer through hole 44 through which the outer projecting portion 55 extends in a tightly fitted state. The dimensions of the outer projecting portion 55 and the outer through hole 44 in the radial direction decrease as the basal end of the outer projecting portion 55 becomes closer in the front-rear direction.

With this structure, the anchoring effect allows the outer projecting portion 55 to firmly contact the inner surface 44a of the outer through hole 44. As a result, the outer projecting portion 55 and, consequently, the edge of the second base portion 51 resist separation from the first base portion 41. Therefore, separation of the second layer 50 can further be restricted.

(1-3) The rear surface 41b of the first base portion 41 and the front surface 51a of the second base portion 51 respectively include the protrusion 46 and the recess 52 and are shaped to engage with each other.

With this structure, the anchoring effect produced by the protrusion 46 and the recess 52 allow the second base portion 51 to firmly contact the first base portion 41. As a result, the second base portion 51 resists separation from the first base portion 41. Thus, separation of the second layer 50 can further be restricted.

### Second Embodiment

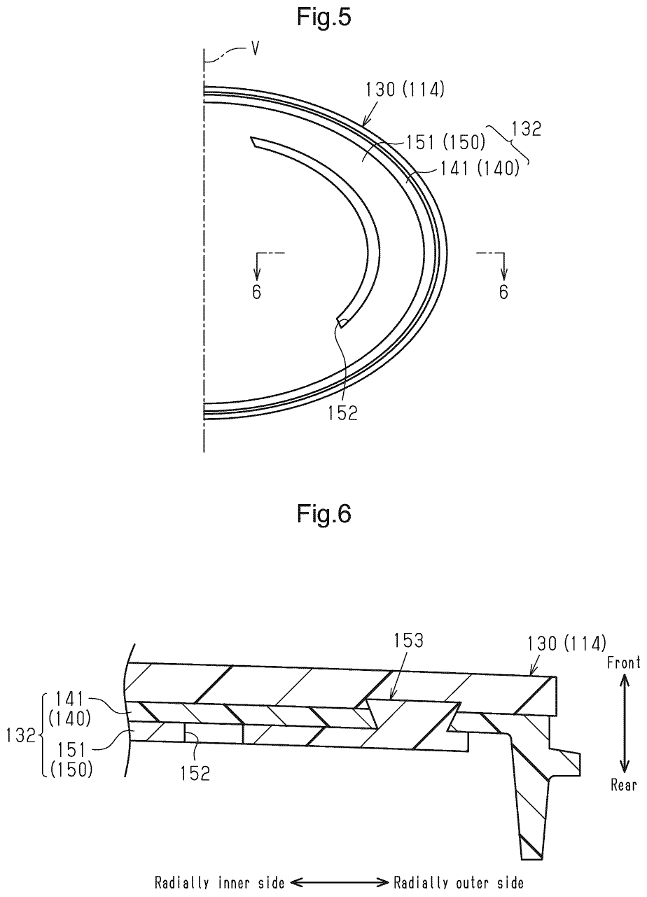

A second embodiment of the vehicle exterior component will now be described with reference to FIGS. 5 and 6. A luminous emblem 114 in accordance with the second embodiment differs from the first embodiment in the structure of a decorative layer 132 of a cover 130.

Description of the second embodiment will focus on differences from the first embodiment. In the second embodiment, components that are the same as those in the first embodiment are each denoted with a reference numeral obtained by adding 100 to the reference numeral used in the first embodiment. Such components will not be described in detail.

A first base portion 141 of a first layer 140 corresponds to a structure in which the protrusion 46 is omitted from the first base portion 41 of the first embodiment.

A second base portion 151 of a second layer 150 includes a bore 152 instead of the recess 52 of the first embodiment. The bore 152 extends through the second base portion 151 of the second layer 150 in the front-rear direction (refer to FIG. 6). The bore 152 extends along the edge of the second base portion 151.

### Advantage of Second Embodiment

The present embodiment has the advantage described below that can be achieved in addition to the advantages (1-1) and (1-2) of the first embodiment.

The bore 152 absorbs relative displacement between the first layer 140 and the second layer 150 in the radial direction caused by the difference in the coefficient of linear expansion between the first layer 140 and the second layer 150. Thus, the second base portion 151 contacts the first base portion 141 more firmly. As a result, the second base portion 151 resists separation from the first base portion 141. Therefore, separation of the second layer 150 can be further restricted.

### Modifications

The above-described embodiments may be modified as follows. The above-described embodiments and the following modifications can be combined as long as the combined modifications remain technically consistent with each other.

Each of the outer projecting portion 55 and the outer through hole 44 exemplified by the present embodiment does not need to have a dimension measured in the radial direction that decreases in the front-rear direction toward a basal end of the outer projecting portion 55. For example, the dimension may be constant in the front-rear direction.

The surface 55a of the outer projecting portion 55 and the inner surface 44a of the outer through hole 44 may be shaped to include a projection and a recess that are engaged with each other. In this case, the anchoring effect allows the outer projecting portion 55 to firmly contact the outer through hole 44.

The protrusion 46 is not limited to the shape, number, and location exemplified in the first embodiment. The protrusion 46 may be modified as long as the protrusion 46 can be arranged on the general portion 45.

In the first embodiment, the protrusion 46 of the first layer 40 may be replaced by a recess. In this case, the recess 52 of the second layer 50 may be replaced by a protrusion that tightly fits into the recess of the first layer 40.

In the first embodiment, the protrusion 46 may be omitted from the first layer 40. In this case, the recess 52 may be omitted from the second layer 50.

The bore 152 is not limited to the shape, number, and location exemplified in the second embodiment. The bore 152 may be modified as long as the location of the bore 152 does not overlap with the location of the projecting portion 153 of the second layer 150 in the front-rear direction.

In the second embodiment, the bore 152 may be omitted from the second layer 150.

The vehicle exterior component of the present disclosure is not limited to the cover 30 arranged in the luminous emblem 14. For example, the vehicle exterior component of the present disclosure may be a simple decorative emblem that does not include the light sources 70 and the housing 20. In this case, the second layer 50 may be formed from acrylonitrile-ethylene-styrene copolymer (AES) instead of the resin material described in the above embodiment.

The vehicle exterior component of the present disclosure may be a luminous emblem arranged in front of a radar device that is configured to transmit and receive electromagnetic waves such as millimeter waves. In this case, the luminous emblem may be formed from a material that is electromagnetic wave transmissive as a whole.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A vehicle exterior component, comprising:
a base layer formed from a resin material having visible light transmittance; and
a decorative layer laminated onto an inner surface of the base layer, wherein
the decorative layer includes a first layer and a second layer that is formed from a resin material having a coefficient of linear expansion differing from that of the first layer,
the first layer includes a first base portion laminated onto and bonded with an inner surface of the base layer, and a peripheral portion projecting from an edge of the first base portion toward an inner side of a vehicle,
the second layer includes a second base portion laminated onto an inner surface of the first base portion, and a projecting portion projecting from the second base portion and extending through the first base portion,
a direction radially extending from a center of the decorative layer is defined as a radial direction, and
the peripheral portion faces a peripheral surface of the second base portion in the radial direction with a gap in between.

2. The vehicle exterior component according to claim 1, wherein
the projecting portion includes an outer projecting portion projecting from an edge of the second base portion,
the first base portion includes an outer through hole that is in close contact with the outer projecting portion,
the projecting portion projects in a direction defined as a projecting direction, and
the outer projection portion and the outer through hole each have a dimension measured in the radial direction that decreases toward a basal end of the outer projecting portion in the projecting direction.

3. The vehicle exterior component according to claim 1, wherein the inner surface of the first base portion and an outer surface of the second base portion include a projection and a recess that are engaged with each other.

4. The vehicle exterior component according to claim 1, wherein the second layer includes a bore extending through the second base portion.
